(19) United States
(12) Patent Application Publication
(10) Pub. No.: US 2019/0122324 A1
(43) Pub. Date: Apr. 25, 2019

(54) Center of Activity Visualization

(71) Applicant: Conduce Inc., Santa Barbara, CA (US)

(72) Inventors: Kevin T. Parent, Santa Barbara, CA (US); Charles G. Law, Los Angeles, CA (US); Ryan P. Clancey, Monrovia, CA (US); Kevin M. Van Leer, St. Louis, MO (US)

(21) Appl. No.: 16/165,861

(22) Filed: Oct. 19, 2018

Related U.S. Application Data
(60) Provisional application No. 62/574,651, filed on Oct. 19, 2017.

(51) Int. Cl. G06Q 50/28; G06Q 10/06

(52) U.S. Cl. CPC G06Q 50/28; G06Q 10/06315

(57) ABSTRACT

Aspects of the current subject matter relate to determining a center of activity for a plurality of entities over a period of time in a given area, such as a warehouse environment, to indicate where the entities are spending the majority of their time. The center of activity may be represented as an average of the center of activity of the locations of the various entities. A visual representation of the center of activity may be provided. An alert system may be established to provide a warning if the center of activity moves outside of a predetermined tolerance range. Recommendations may be generated based on the center of activity and frequency data relating to areas of high use or access.

### CROSS-REFERENCE TO RELATED APPLICATIONS

This application claims priority to U.S. Provisional Patent Application No. 62/574,651, filed on Oct. 19, 2017, the contents of which are herein incorporated by reference in its entirety.

### BACKGROUND

Distance traveled by human operators and/or equipment in a warehouse (or similar environment) has a profound impact on the operations of the warehouse. For example, for loading operations in which various items are selected from warehouse storage areas and loaded in a packing area or a loading area, any extra distance that humans and/or equipment must travel to perform these operations results in a decrease of the number of loads achieved in a given period of time. Each extra step taken by a human or distance traveled by a piece of equipment thus results in the expenditure of extra time and extra money.

Thus, identifying and tracking the movement of humans and/or equipment is critical to being able to optimize operations in a warehouse or similar environment.

### SUMMARY

Aspects of the current subject matter relate to identifying a center of activity indicative of human and equipment movement over a period of time in a given area.

According to one aspect, a method includes obtaining, by a server, location data for a plurality of entities over a first period of time in a defined area; calculating, by the server and based on the location data, a center of activity as an average location of the plurality of entities over the first period of time; generating, by the server, one or more visual representations of the calculated center of activity with respect to the first period of time and the defined area; providing, by the server and to one or more user devices for display on a respective user interface, the one or more visual representations of the calculated center of activity; and providing, by the server and to the one or more user devices, an indication in response to a determination that the calculated center of activity moved outside of a predefined tolerance range.

In some variations, one or more of the features disclosed herein including the following features can optionally be included in any feasible combination. The center of activity may be a weighted, instantaneous average, weighted by a number of the plurality of entities. The one or more visual representations may include an indicator overlaid on a diagram of the defined area, the indicator positioned at the calculated center of activity. The one or more visual representations may further include data from one or more additional data streams. The method may further include obtaining, by the server, location data for the plurality of entities over a second period of time in a defined area; and calculating, by the server, a second center of activity as an average location of the plurality of entities over the second period of time; where the one or more visual representations include an indicator of the second center of activity. The method may further include determining, by the server, one or more points in the defined area accessed most frequently during the first period of time; and providing, by the server and to the one or more user devices, an analysis including a recommendation to move the one or more points within the defined area. Each of the plurality of entities may include a Wi-Fi enabled device, and the location data may be obtained via one or more access points configured to receive timing and/or positioning data from the plurality of entities.

In an inter-related aspect, an apparatus may include at least one processor; and at least one memory including computer program code, the at least one memory and the computer program code configured to, with the at least one processor, cause the apparatus to at least: obtain location data for a plurality of entities over a first period of time in a defined area; calculate, based on the location data, a center of activity as an average location of the plurality of entities over the first period of time; generate one or more visual representations of the calculated center of activity with respect to the first period of time and the defined area; provide, to one or more user devices for display on a respective user interface, the one or more visual representations of the calculated center of activity; and provide, to the one or more user devices, an indication in response to a determination that the calculated center of activity moved outside of a predefined tolerance range.

In an inter-related aspect, a computer program product may include a non-transitory machine-readable medium storing instructions that, when executed by at least one programmable processor, cause the at least one programmable processor to perform operations including: obtaining location data for a plurality of entities over a first period of time in a defined area; calculating, based on the location data, a center of activity as an average location of the plurality of entities over the first period of time; generating one or more visual representations of the calculated center of activity with respect to the first period of time and the defined area; providing, to one or more user devices for display on a respective user interface, the one or more visual representations of the calculated center of activity; and providing, to the one or more user devices, an indication in response to a determination that the calculated center of activity moved outside of a predefined tolerance range.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to warehouse operations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 is a block diagram representation of a system in which a visualization technique consistent with implementations of the current subject matter may be implemented;

FIGS. 2A-6C are exemplary visual representations of a warehouse layout incorporating visualization techniques consistent with implementations of the current subject matter;

FIG. 7 is a flowchart illustrating a method related to aspects of identifying a center of activity indicative of human and equipment movement over a period of time in a given area; and

FIGS. 8A-8I illustrate results of a simulation model used to validate a center of activity technique consistent with implementations of the current subject matter.

When practical, similar reference numbers denote similar structures, features, or elements.

### DETAILED DESCRIPTION

Aspects of the current subject matter relate to a visualization technique for monitoring and/or tracking activity in warehouses or other environments. More particularly, a center of activity indicative of human and/or equipment movement over a period of time in a given area is determined, tracked, stored, and/or presented to one or more users or systems. The center of activity, according to implementations described herein, may be used to reduce distance traveled by humans and/or equipment.

Although certain aspects are described with respect to a warehouse and warehouse operations and environments, the subject matter is not limited to such uses. The center of activity identification, tracking, and visualization approaches consistent with implementations described herein may be utilized in various other operations and environments such as, for example, an airport, an assembly line, a retail store, a geographical area, or essentially any environment in which it is desirable to track movement of humans and/or equipment. Therefore, when a warehouse or similar environment is described elsewhere herein, the description may apply to other operations and environments as defined herein.

In an example of a warehouse environment, order picking—the process of retrieving requested items from shelves—is the most expensive component of typical warehouse operations, accounting for approximately 55% of total operating cost. Of the picking expense, 60% is attributed to travel time—the time it takes a worker to travel from one place to another in the warehouse. Therefore, reducing travel time in a warehouse can have a significant impact on the operating cost in the warehouse.

A key factor impacting travel distance is the organization of items in the warehouse, which may also be referred to as “slotting.” Placing the most frequently picked items (or stock keeping units (SKUs)) nearest to the door or packing area, with less frequently picked SKUs stored farther back, reduces distance traveled over time and reduces the associated costs. For many types of warehouses, a priori data for SKU pick frequency (also known as “velocity”) is unavailable. This is particularly the case for both third-party logistics operators who often do not have visibility into sales figures or promotions for their customers' SKUs, and for warehouse operators that store many different SKUs with frequent changes in inventory, such as fulfillment centers for online shopping that are subject to consumer buying trends. Warehouse operators need an independent means for detecting and responding to changes in the velocity of their SKUs, so they can reorganize their warehouse for maximum efficiency. This type of analysis is inherently temporal and spatial. The center of activity, according to implementations described herein, provides for visualizing the operation in several specific ways, with the ability to explore the visualization through time and space to identify opportunities for increased efficiencies in warehouse layout and slotting.

The center of activity, according to aspects of the current subject matter, is a point or area reflective of averaged locations of humans and/or equipment over a period of time in a given area. The center of activity may be an important factor in understanding and optimizing movement of humans and equipment in, for example, a warehouse or similar environment in which each movement or distance traveled by a human and piece of equipment affects operations. Thus, it is desirable to be able to visually monitor human and equipment movement to identify a point or area encompassing the center of activity and to identify movement of the center of activity.

Ideally, the center of activity for a particular environment such as a warehouse is a point or area that minimizes distance traveled by the humans and equipment involved in the warehouse operations. As the center of activity moves away from the ideal point or area, this may indicate that the efficiency of the operations being performed may be decreasing. According to some aspects of the current subject matter described herein, the center of activity is monitored against a specific target location. If the center of activity is greater than a threshold distance away from the target location, a warning or indication may be generated.

The center of activity may be thought of as a concentrated heat map of activity in the warehouse. The center of activity may be displayed as a moving marker superimposed on a map or layout of the warehouse. The location of the marker represents an averaging of locations over time for all the activity in the warehouse, as sensed by a location tracking system. When the center of activity drifts toward the back of the warehouse, this is an early indication that more trips are being made to the back of the warehouse and reorganization of the inventory may be warranted. Similar to “condition-based maintenance” for machinery, the center of activity provides an optimized condition-based indicator for the right time to perform maintenance on the inventory by making, for example, slotting adjustments in the warehouse.

The center of activity technique, according to aspects of the current subject matter, may be inexpensive to implement and does not require any significant infrastructure investment. Some of the least expensive indoor location sensing systems (also known as “indoor positioning” systems) rely on existing Wi-Fi infrastructure, but these also tend to be among the least accurate. In sharp contrast, the center of activity, consistent with implementations of the current subject matter, is highly effective even in such environments because it is tolerant of very large amounts of noise and distortion that reduces the measurement accuracy in other systems. The result is that the center of activity approach produces significant efficiency gains in warehouse operations at very low cost.

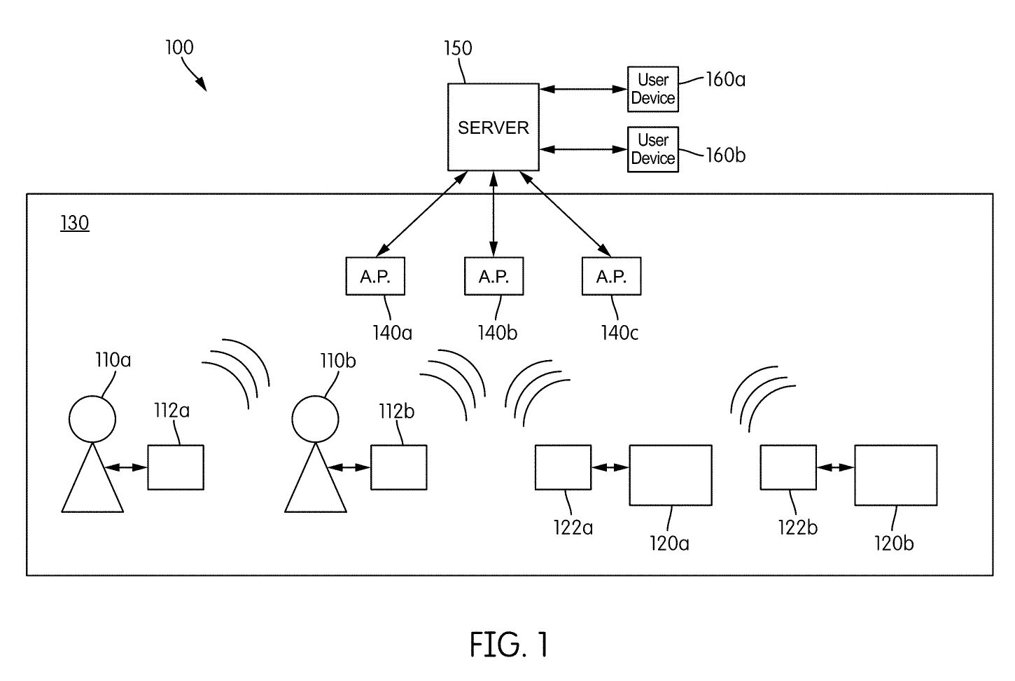

FIG. 1 is a block diagram representation of an exemplary system 100 in which the center of activity visualization technique consistent with aspects of the current subject matter may be implemented. In particular, center of activity identification and tracking may be implemented by the system 100. As the center of activity relates to a point or area at which a majority of activity occurs over a time period in a given area, location data of various entities (e.g., humans and equipment) is needed, according to some aspects of the present subject matter, to identify or otherwise determine the center of activity. By utilizing location data over time, a determination may be made as to a point or area at which the most amount of time is spent by the humans and equipment. This point or area is the center of activity.

The center of activity may be mathematically represented as follows:

$$C ( t ) = \frac{{\sum }_{i} {\sum }_{j} {V}_{ij} ⋆ {w}_{ij} ⋆ \frac{{e}_{ij} ( t ) - {s}_{ij} ( t )}{Δ t}}{{\sum }_{i} {\sum }_{j} {w}_{ij} ⋆ \frac{{e}_{ij} ( t ) - {s}_{ij} ( t )}{Δ t}}$$

In this representation, t=current time; Δt=lookback period; e=set of all events occurring within the area in question; eᵢ=events in e with source i; e_{i,j}=event j in eᵢ; V_{i,j}=location of event e_{i,j}; w_{i,j}=weight of event e_{i,j}; s_{i,j}=time of event e_{i,j}; e_{i,j}=time of event e_{i,j+1}; s_{i,j}(t)=max(min(s_{i,j}, t), t−Δt); and e_{i,j}(t)=max(min(e_{i,j}, t), t−Δt).

Alternatively, the center of activity may be mathematically represented as follows:

$$C ( t ) = \frac{{\sum }_{i} {\sum }_{j} {V}_{ij} ⋆ {w}_{ij}}{{\sum }_{i} {\sum }_{j} {w}_{ij}}$$

In this second representation, duration, which is a form of weighting, is not taken into account.

With further reference to FIG. 1, the system 100 includes various entities including human operators 110 with devices 112 and various pieces of equipment 120 with devices 122 in a defined area 130. Additional or different entities may also be incorporated. Although two human operators 110a,b (with respective devices 112a,b) and two pieces of equipment 120a,b are shown (with respective devices 122a,b), these numbers are merely for illustration purposes and may be increased or decreased accordingly. Moreover, the equipment devices 122 need not be separate devices from the respective pieces of equipment 120 but may instead be incorporated within the respective pieces of equipment 120. The pieces of equipment 120 may be forklifts, automated machines, or the like capable of moving, loading, and performing other operations suitable for the intended environment.

The devices 112 and 122 may be scanner devices or the like capable of reading barcode labels. The devices 112 and 122 may be any type of mobile or handheld or other device capable of receiving and transmitting data, such as location data indicative of the current location of the device 112 or 122. To that end, the devices 112 and 122 may be Wi-Fi enabled devices that provide timing or positioning data or other signaling data to one or more access points 140 (shown are three access points 140a,b,c) positioned within the defined area 130. The access points 140 are configured to receive (e.g., periodically or continuously) the data from the devices 112 and 122 and transmit the data to a server 150 for processing consistent with implementations of the current subject matter described herein. The server 150 may be a remote server including one or more processors, and may communicate with the access points 140 over a network or other connection.

The server 150 may receive signal data for a particular device 112 from one or more access points 140 (such as access points 140a,b,c), and may use triangulation, multilateration, signal directionality, or other known methods to accurately determine the location of the particular device 112. The server 150 may store the determined location data for each of the devices 112a,b and 122a,b. Each stored location is associated with a particular time at which the device 112,ab or 122a,b was at the location.

The addition of more access points 140 may increase the precision of the determination of the location of the devices 112, 122. Moreover, additional hardware including one or more antennae and/or antenna arrays may be incorporated to also increase the precision.

In accordance with implementations of the current subject matter, the server 150 uses the received or determined location data to determine the center of activity over a period of time in a given area (e.g., the defined area 130). The center of activity may be an average of the center of activity of the locations of the various entities (e.g. the human operators 110 and the pieces of equipment 120) over a given time period (e.g., day, week, month, etc.). The average may be a weighted average, where the weighting is by the number of entities. The server 150 is configured to generate reports and/or visual representations of the center of activity data, which may be provided from the server 150 to one or more user devices 160 (e.g., 160a,b) on respective user interfaces that allow for user viewing and, in some instances, user selection and control. Through the user interfaces, the center of activity may be viewed as an indicator of where entities are spending their time.

Various methods for sensing the location of moving entities within a location, such as an indoor warehouse, may be used to determine the center of activity consistent with implementations of the current subject matter. Such positioning technologies may include infrared, visible light communication (VLC), ultrasonic, audible sound, Wi-Fi (as discussed above), Bluetooth, ZigBee, RFID, ultra-wideband (UWB), geomagnetic, inertia, ambient sound, ambient light, and computer vision.

In many warehouse environments, it is important to optimize on total cost of ownership. This requires selecting a technology with building-wide coverage and low initial and ongoing operating costs. Wi-Fi and Bluetooth positioning systems are both viable from this perspective, although as noted above other systems may be utilized in the center of activity technique described herein. Moreover, many warehouse environments already have Wi-Fi infrastructure in place for communication with hand scanners (for scanning barcodes) and tablet computers (for processing orders and directing tasks). Such a Wi-Fi infrastructure or the like also exists in other environments, such as airports, retail centers, and factories. A software layer on top of the basic Wi-Fi infrastructure, may be used for indoor positioning; however, the accuracy of the position information is highly sensitive to various factors including the quantity of Wi-Fi access points in the environment. The system is also subject to signal noise and distortion effects due to the radio frequency environment and the physical structure, including the shelving. Without the addition of many more Wi-Fi access points, or the addition of expensive precision access points designed for the purpose of locating entities, location accuracy can be quite low in a warehouse environment, with a large range of possible location for a particular entity being a possibility (i.e., such systems have a high level of uncertainty). Thus, in such a noisy signal environment, the visualization technique used must compensate for these inaccuracies. The center of activity method according to implementations described herein accomplishes this by averaging over many samples over a period of time.

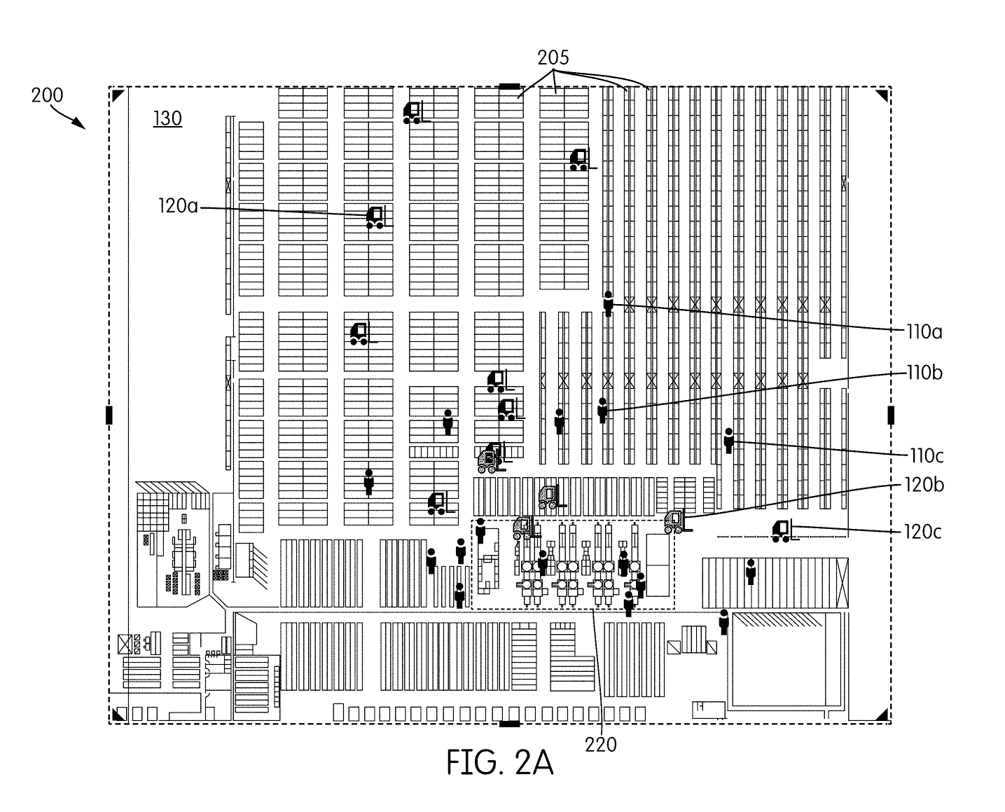

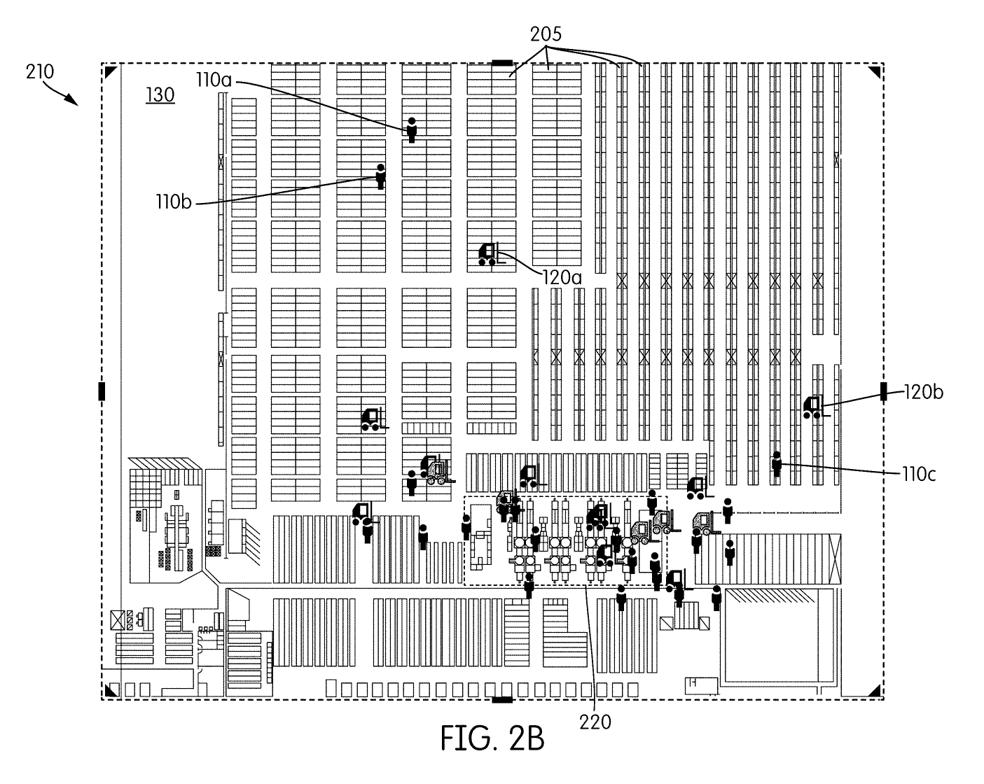

With reference to FIGS. 2A and 2B, visual representations 200 and 210, generated by the server 150, of an exemplary warehouse layout (e.g., the defined area 130) with a plurality of shelves, racks, and/or storage bins 205 are provided. The visual representations 200, 210 may be provided on the user interfaces of the user devices 160a,b. A packing area 220 (which may include one or more loading surfaces, tables, shelves, racks, bins, etc.) is shown as part of the warehouse layout, as well as various human operators 110 and pieces of equipment 120 as icons overlaying the warehouse layout. The visual representations 200 and 210 show example positions (e.g., those of the human operators and pieces of equipment) at distinct points of time. The various shelves and racks represent areas in which items are stored. In the exemplary warehouse environment, the items need to be located and moved to the packing area 220. The center of activity would ideally be positioned at or near the packing area 220. Although human operators 110a,b,c and equipment 120a,b,c are labeled, additional or fewer operators or pieces of equipment may be present within the defined area 130, and the number may change throughout a given period of time.

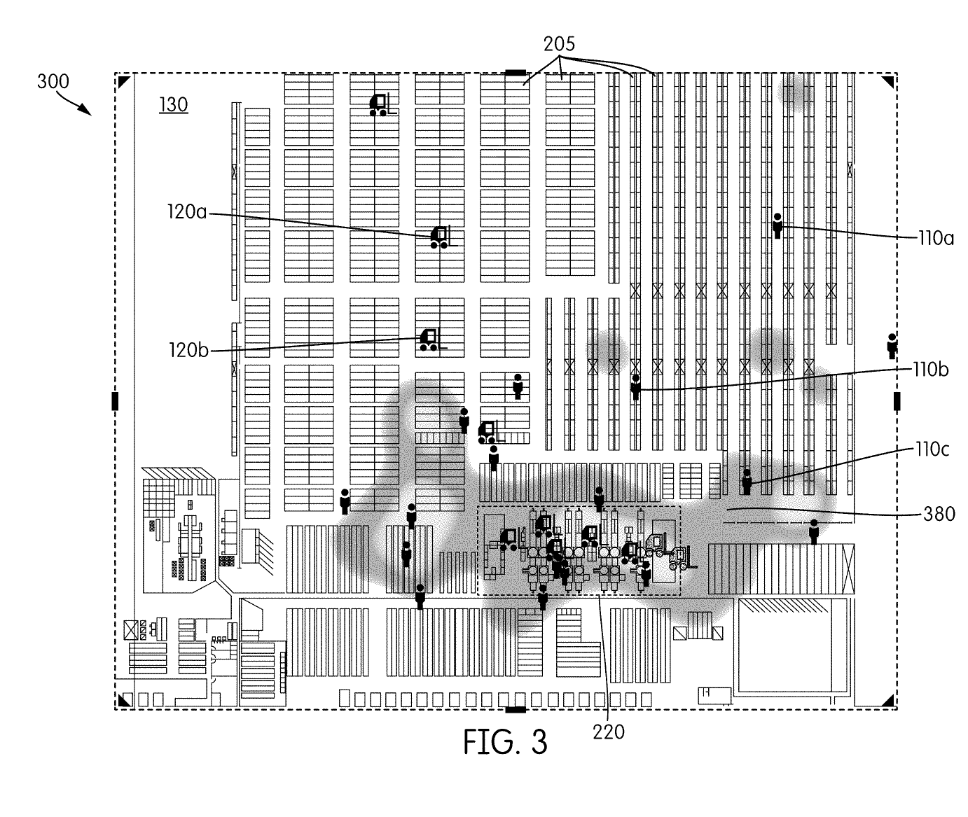

FIG. 3 is a visual representation 300, similar to those shown in FIGS. 2A and 2B and also including a heat map 380 that is a visual representation aggregated over time with intensity levels (represented by various levels of shading) indicating frequency of the entities in a certain place (darker areas are those with a higher frequency than lighter areas). The visual representation 300 may be provided on the user interfaces of the user devices 160a,b.

While heat maps may be valuable in providing an analyst a sense of the overall activity profile, they do not offer a quantitative measure of activity that can be used to optimize sorting and travel distance in a warehouse. The center of activity technique consistent with implementations of the current subject matters offers an alternative or additional visualization to address this shortcoming. The center of activity may be thought of as a concentrated heat map—one in which the total activity over a span of time is represented as a single moving point atop the map of the warehouse. The point may be a circle or other shape. The location of the point represents an averaging of all the sensed locations of activity in the warehouse or other environment.

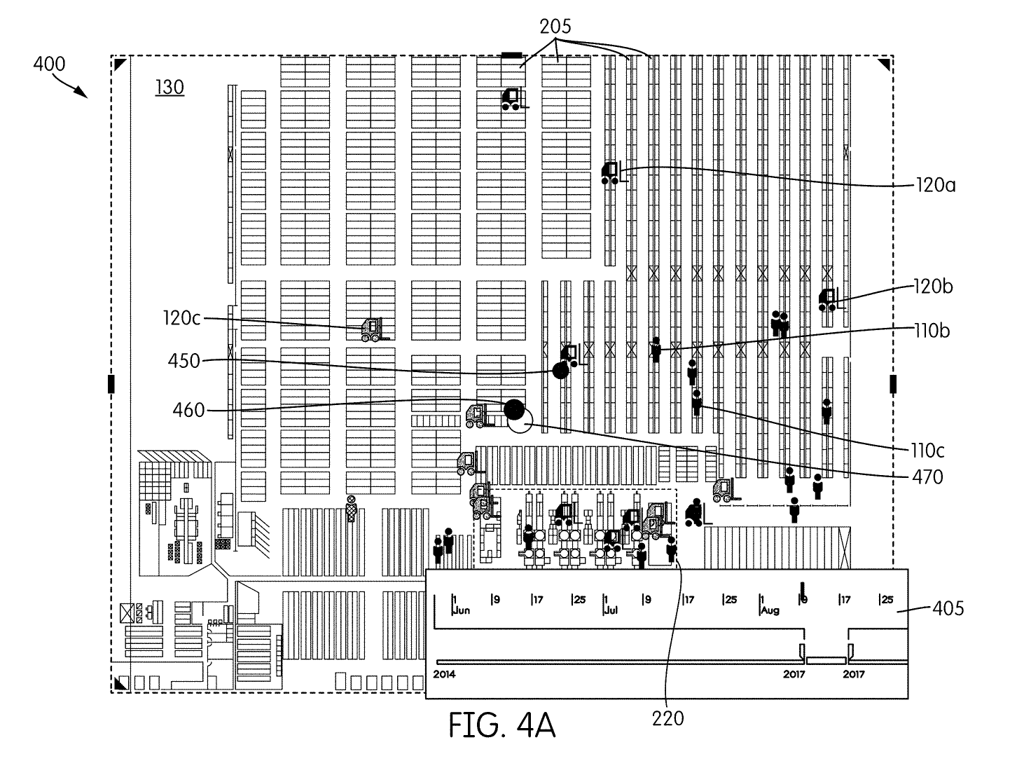

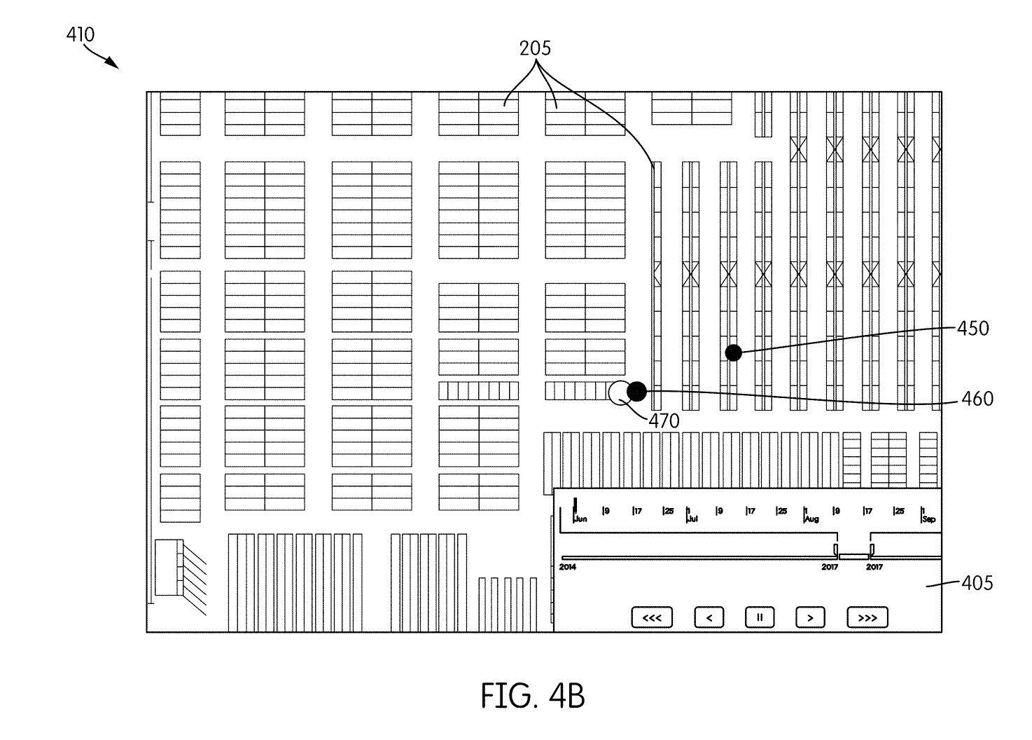

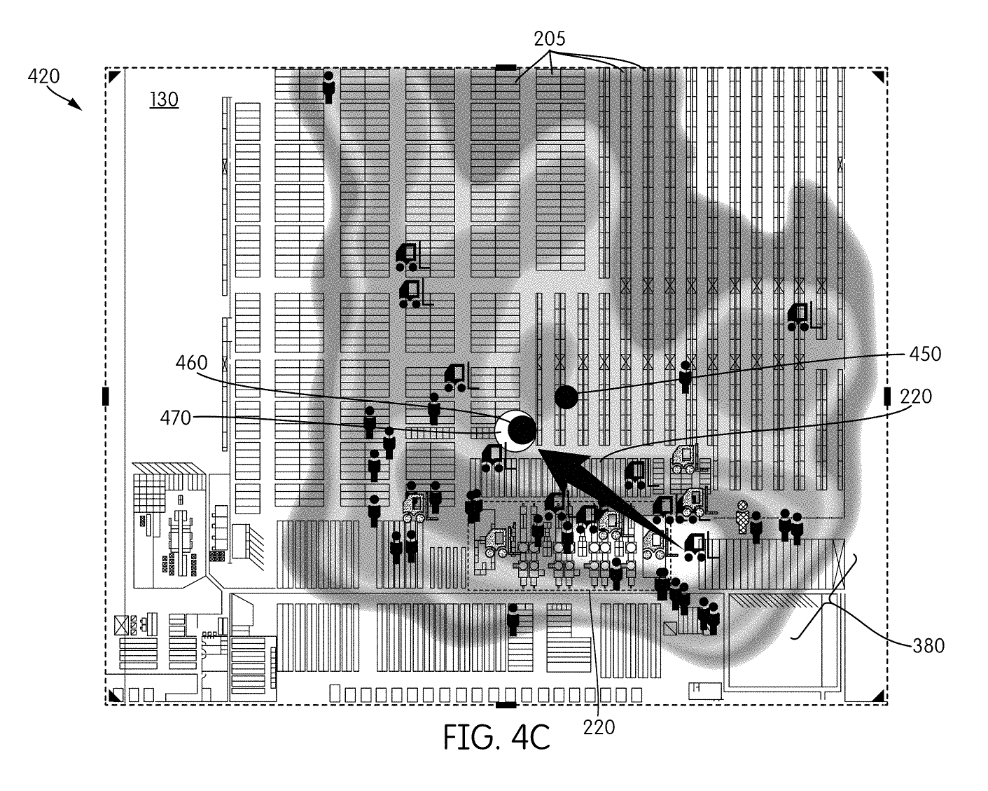

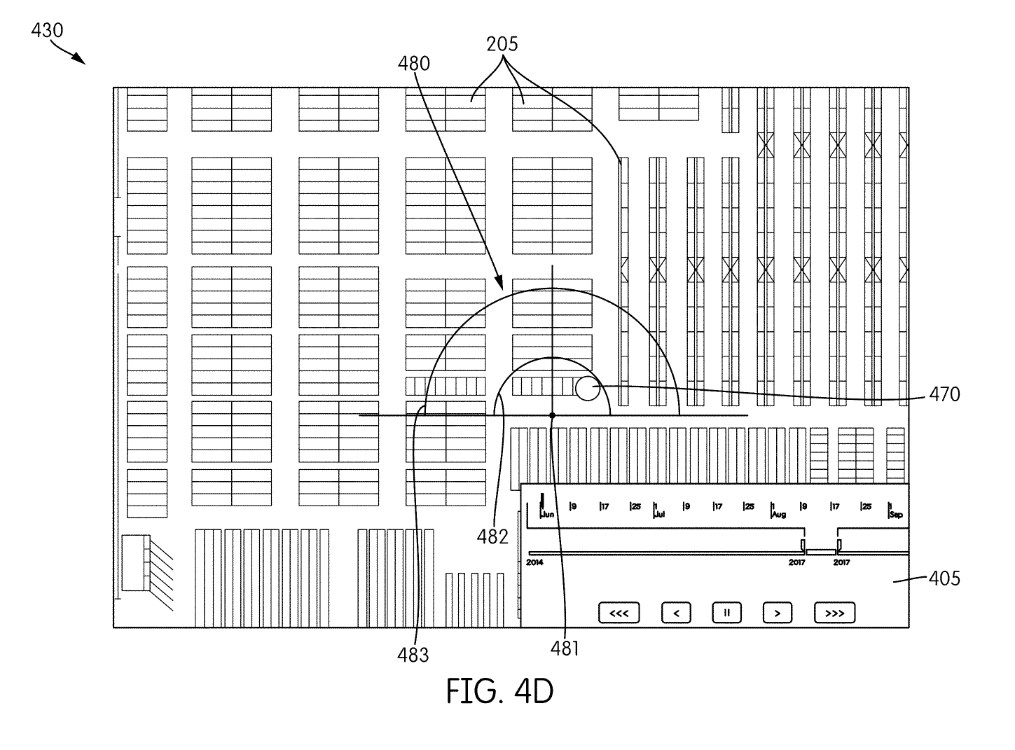

FIGS. 4A, 4B, 4C, and 4D are visual representations 400, 410, 420, and 430, respectively, generated by the server 150 for viewing, via one or more user devices 160a,b, of an exemplary warehouse layout with center of activity indicators 450, 460, and 470 overlaying the warehouse components. 450 may represent a daily center of activity, 460 a weekly center of activity, and 470 a monthly center of activity. In some instances, fewer or additional center of activity indicators may be provided. In some instances, the center of activity indicators may be representative of other or additional time periods (e.g., quarterly, annually, or a predetermined or selected time period). The representation 400, as shown in FIG. 4A, with the center of activity indicators 450, 460, and 470 is provided at a distinct point of time also showing positions of various entities (via respective icons atop the warehouse layout) at that point of time. The representation 420 also includes the heat map 380 as another indicator of the position of the entities 210 and 220 over time. Each of the representations 400, 410, and 420 clearly portray that the center of activity is, in each case in the examples provided, moved away from the packing area 220. While circles of various sizes are used as the center of activity indicators, other indicators of various shapes, colors, and sizes may also be used. The average activity is typically calculated over a period of time such as an hour, a day, a week, a month, a quarter, or a year, but may be instantaneous as well or may cover a user selected or predefined time period. More than one point in different colors, sizes, or shapes may be displayed simultaneously, each representing a different time period. Controls for setting desired periods of time or indicating the periods of time represented by the center of activity may also be provided, as shown in FIGS. 4A and 4B. For example, user input controls 405 may allow for user selection of one or more time periods for which to determine and display the center of activity.

When the center of activity moves a certain distance from the ideal location, as defined by a human operator or an automated algorithm, a reorganization of the warehouse may be desirable or required. As such, it may be valuable to also have a reticle or bullseye representation behind the center of activity to indicate when the center of activity has moved a certain distance. The representation 430 of FIG. 4D illustrates this concept by incorporating a reticle 480 with a center point 481, a first outer circle 482, and a second outer circle 483. The center point 481 may be set, automatically or manually, based on a location of the center of activity for a time period that is considered to be very efficient based on other measurements (such as picks per hour). The outer circles 482 and 483 may be based on various targets for daily efficiency. For example, the first outer circle 482 may represent a desired target, and if the center of activity indicator 470 is between the center point 481 and the first outer circle 482, the desired target is met. If the center of activity indicator 470 moves past the first outer circle 482, in between it and the second outer circle 483 or past the second outer circle 483, a warning (for example, a message, such as a pop-up message, or a change, such as a change in the color or size, in the center of activity indicator 470) may be generated and displayed, for example. Additional circles may be incorporated to define more precise targets or to cover a larger area of the defined area 130.

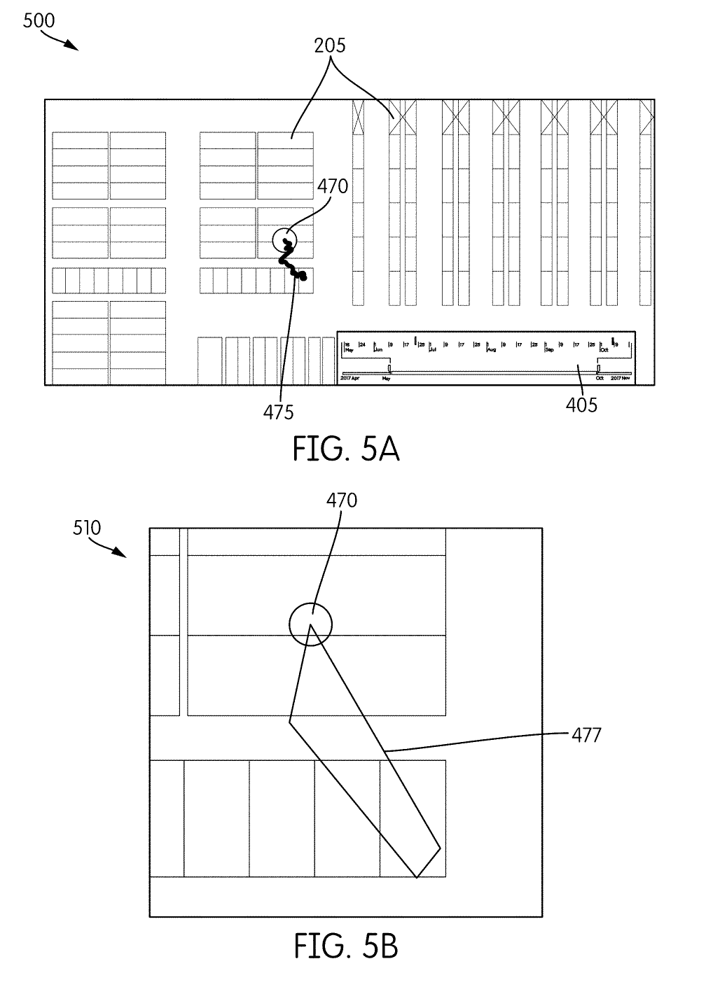

FIGS. 5A and 5B are exemplary visual representations 500 and 510, respectively, generated by the server 150 for viewing on one or more user devices 160a,b. The visual representations 500 and 510 may indicate how the center of activity (e.g., the monthly center of activity 470) has changed over a period of time (e.g., six month or other period of time). As the center of activity generally moves over time, it may be of interest to see this movement, indicating changes in activity within the warehouse. The line 475 indicates the movement of the center of activity 470 to the current point of the center of activity shown in FIG. 5A. The irregular shape 477 shown in FIG. 5B overlapping the indicator 470 represents the extent of the movement of the center of activity over a particular time period. Over that span, in this example, the center of activity moved in a range bounded by the four-sided FIG. 477. Since movement of the center of activity is ultimately an indication of change in warehouse activity, this bounding shape approach is useful in highlighting that motion.

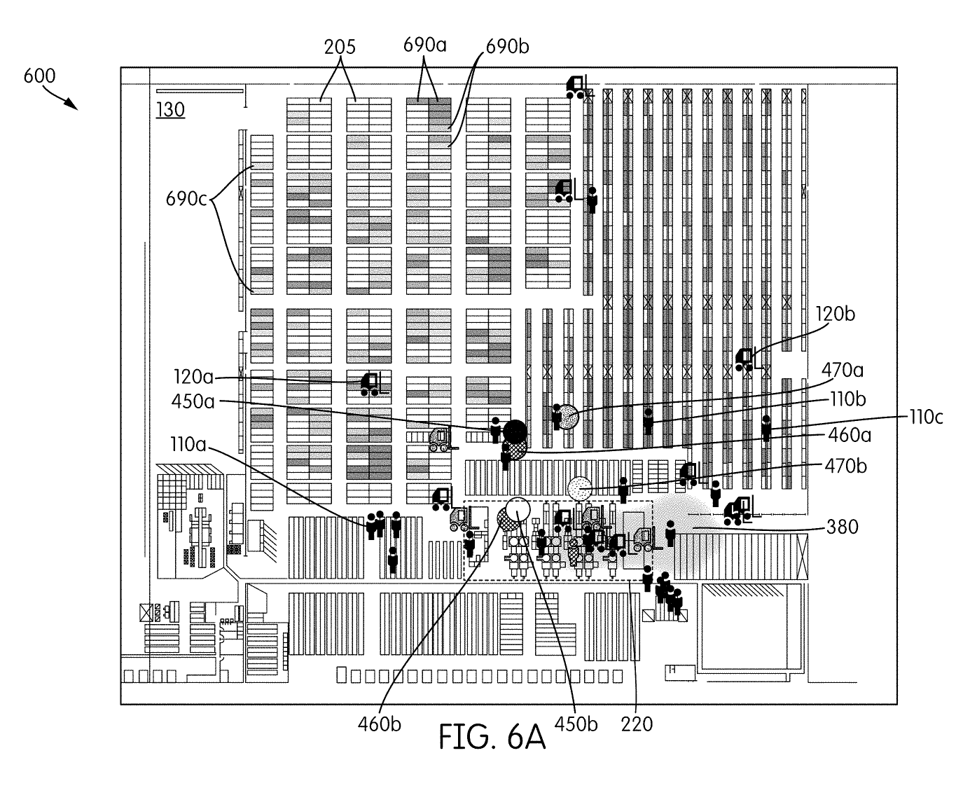

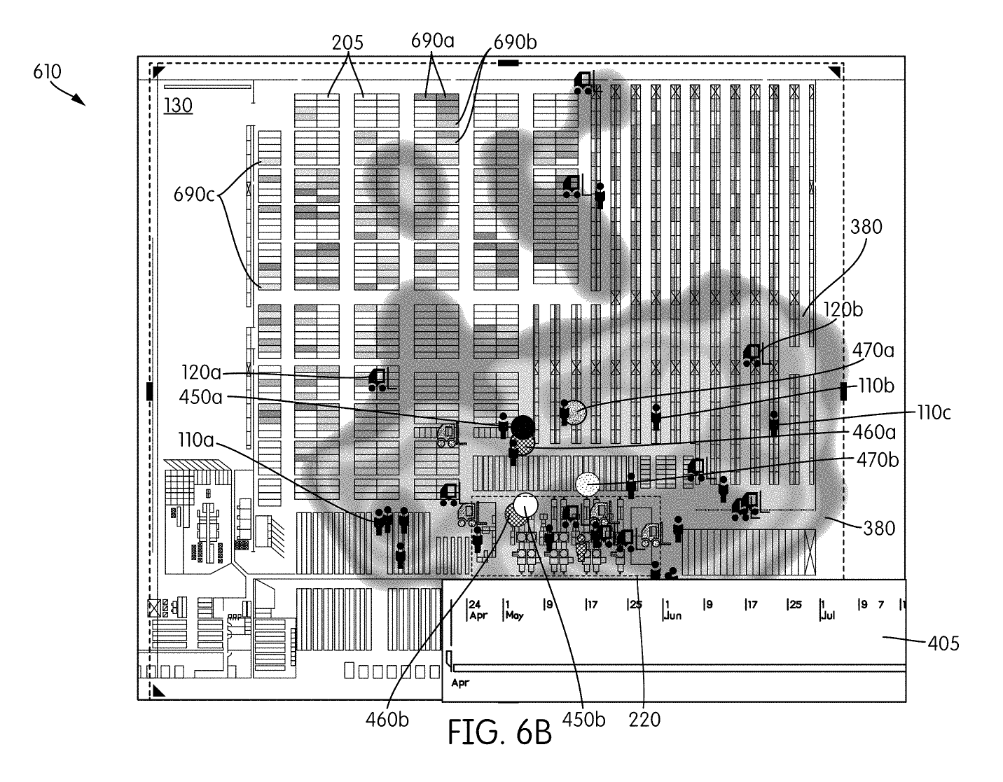

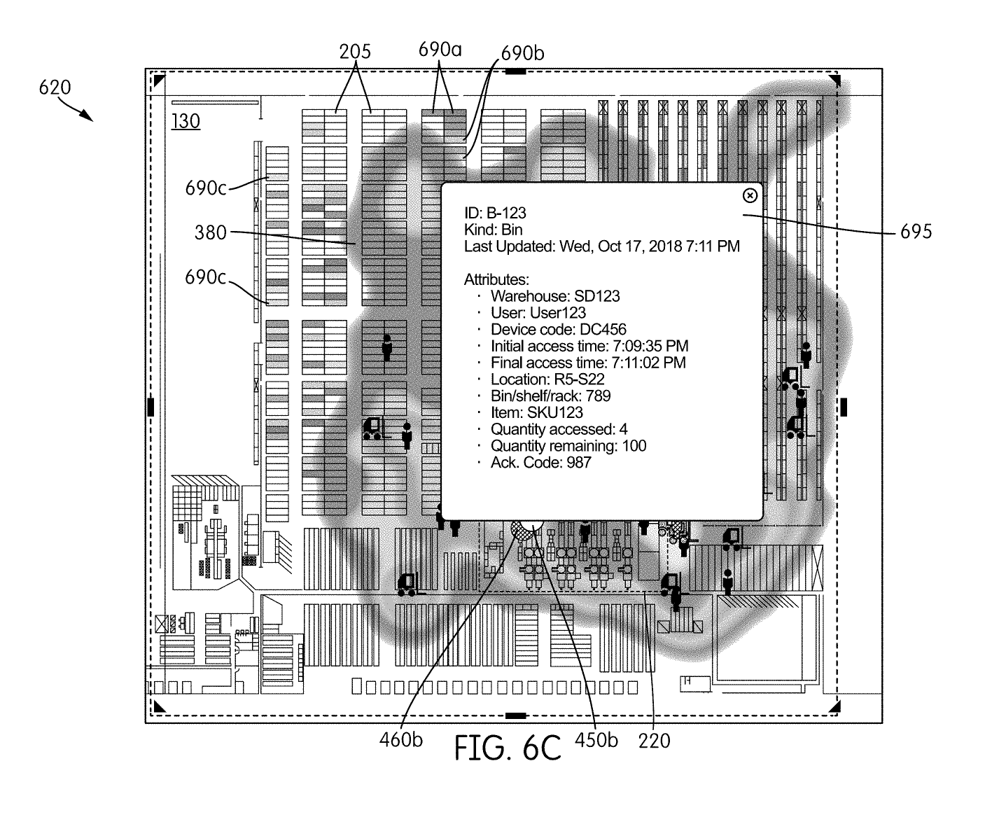

FIGS. 6A, 6B, 6C are visual representations 600, 610, 620, respectively, illustrating other types of information overlaid with the center of activity indicators 450a,b, 460a,b, and 470a,b for viewing and possible user selection via one or more user devices 160a,b. For example, the representation 600 of FIG. 6A illustrates a storage rack frequency coding scheme (e.g., high 690a/medium 690b/low 690c frequency), with darker colors indicating those racks more frequently accessed (a few of the color-coded portions are labeled to allow for other details to be clearly shown). The frequency coding scheme may have additional or fewer variants to indicate frequency (e.g., two, four, five, or more frequency levels). Other visual indicators (such as symbols, shading, etc.) to indicate frequency of use or access may also be utilized. The representation 610 of FIG. 6B also shows the heat map 380, in addition to the center of activity indicators 450a,b, 460a,b, and 470a,b and the storage rack frequency coding scheme 690a,b,c. And, the representation 620 also shows a pop-up window 695 containing information about a particular storage rack or section. Thus, according to some implementations of the current subject matter, the determined center of activity indicators may overlay additional data streams. The pop-up window 695 may be presented upon user selection of the corresponding storage rack or section in the representation 620.

Consistent with implementations of the current subject matter, the center of activity may be determined hourly, daily, weekly, monthly, and/or for any desired period of time. For example, a center of activity may be determined for a single snapshot of time. Reports including the visual representations described herein may be sent from the server 150 to one or more user devices 160a,b. The visual representations may be sent periodically, consistent with the period of time in which the center of activity is being determined. Alternatively or additionally, the visual representations may be sent on-demand in response to a request from a user or according to some other predefined schedule.

In the example of warehouse operations as described herein, and as briefly described above, the center of activity is ideally at a point that minimizes distance traveled by the human operators and the pieces of equipment. Such a point may be a loading or packing area. To increase efficiency within the warehouse, by minimizing distance traveled, frequently picked items are ideally stored near the packing area and seldom picked items are stored near the back of the warehouse, farther away from the packing area.

The determined center of activity may be used as an optimizing and/or analyzing tool for managers or operators of a warehouse. For example, if a center of activity is shown to be away from its ideal target location for a particular period of time, this may serve as an indication that the inventory in the warehouse needs to be reorganized as one or more items placed a distance away from the packing area have, for example, increased in popularity and need to be placed nearer to the packing area. On the other hand, for a particular time period in which the center of activity is away from its ideal target location, a determination may be made that there is a legitimate reason for such a shift due to, for example, one specific order that is unlikely to happen again. This determination may be made by, for example, comparing the center of activity before and after the particular time period. If the center of activity before and after the particular time period is equivalent (or equivalent within a threshold amount) to one another, then the center of activity for the particular period may be flagged as an outlier result. Additionally, a recommendation may be made to monitor the center of activity over a longer time period to more accurately determine if there is a consistent shift in the activity.

Additional data, such as those shown in FIGS. 6A-6C, may also be used to assist in the determinations for optimization and analysis of the warehouse layout. For example, in processing the center of activity calculations, the server 150 determines the racks or shelves most frequently accessed, where the determination is based on the determined and/or sensed locations over time that indicate activity in the warehouse (which is what the frequency coding scheme 690a,b,c represents). By determining the one or more areas/rack/shelves/bins most frequently visited and/or accessed, the server 150 may provide this information (e.g., as a recommendation) to a user.

Additionally, sensors on the material handling equipment (MHE) itself (forklifts, etc.) may track the overall utilization of the equipment, and based on the overall utilization, suggestions for making adjustments to the fleet size and makeup may be made.

The center of activity visual representations, consistent with implementations described herein, provide a visual and spatial metric. While a warehouse may measure picks per hour, the center of activity visual representation adds an additional layer by indicating how the layout of the warehouse is affecting the picks per hour.

The center of activity visual representations also serve as an early warning system that may be used to signal the initiation of condition-based maintenance, rather than the typical schedule-based maintenance. The server 150 may be configured to monitor the center of activity with respect to a specific target location. The specific target location may be the desired point or area for the center of activity, such as near a packing area. Monitoring the observed center of activity versus the specific target location serves as an indication if the observed center of activity moves away from the target location more than a prescribed amount. For example, a threshold distance may be established and provided to the server 150. If the observed center of activity is at least a threshold distance away from the specific target location, then an alert may be provided via, for example, a message to the one or more user devices 160.

An additional advantage of the center of activity visualization technique described herein is that no additional hardware (such as sensors) is required to be installed in the warehouse or other environment in which the center of activity visualization technique is being implemented. Warehouses typically employ the Wi-Fi infrastructure or a similar communication system including the devices and access points described herein with respect to FIG. 1. The entities (e.g. the human operators 110 and the pieces of equipment 120) utilize their respective devices 112 and 122 for performing loading and other operations. The access points 140 are displaced throughout the defined area 130 for keeping track of the devices 112 and 122. And, the server 150 communicates with the access points 140 and user devices 160 for various reporting and inventory functions in a warehouse environment.

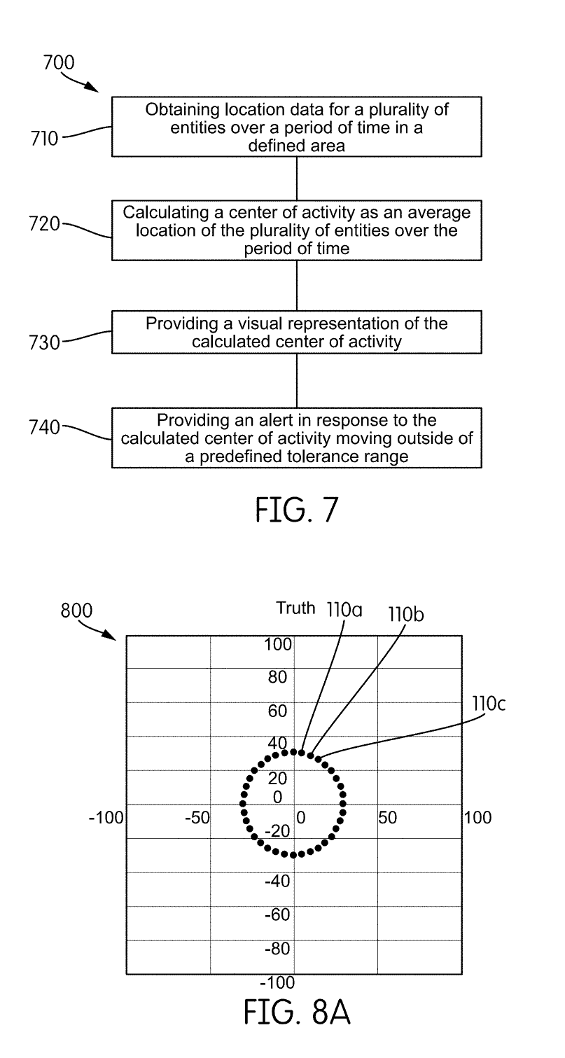

With reference to FIG. 7, a process flow chart 700 illustrates features of a method, which may optionally include some or all of the following. At 710, location data for a plurality of entities over a period of time in a defined area is obtained. For example, as described above, the devices 112 and 122 associated with various humans 110 or pieces of equipment 120 may provide timing, positioning, or other signaling data to the one or more access points 140 positioned within the defined area 130. The access points 140 transmit the data to the server 150 for processing consistent with implementations of the current subject matter described herein.

At 720, the center of activity is calculated as the average location of the plurality of entities over the time period. The center of activity may be calculated using the expression provided and described elsewhere herein.

At 730, one or more visual representations associated with the calculated center of activity is provided. As descried above, the visual representation may be of a variety of representations. For example, one or more indicators (e.g., the center of activity indicators 450, 460, 470) may be overlaid a map or layout of a warehouse or other environment. Various icons may be used to show, in real-time or at a particular time, location of one or more entities. Heat maps, time selection tools, pop-up windows, frequency coding schemes, movement of the center of activity, features of the warehouse or other environment (e.g., shelves, bins, etc.) and the like may be provided with the one or more visual representations consistent with implementations of the current subject matter. Moreover, the particular type of representation or representations to be provided may be selected by a user via the user interface of one of the user devices 160a,b.

At 740, an alert is provided when the calculated center of activity moves outside of a predefined tolerance range. For example, if the observed center of activity is at least a threshold distance away from the specific target location, then an alert may be provided via, for example, a message to the one or more user devices 160. Additionally or alternatively, other optimization and analysis results may be generated by the server 150 and provided. For example, a recommendation related to a high frequency area or a recommendation to utilize other time periods may be provided.

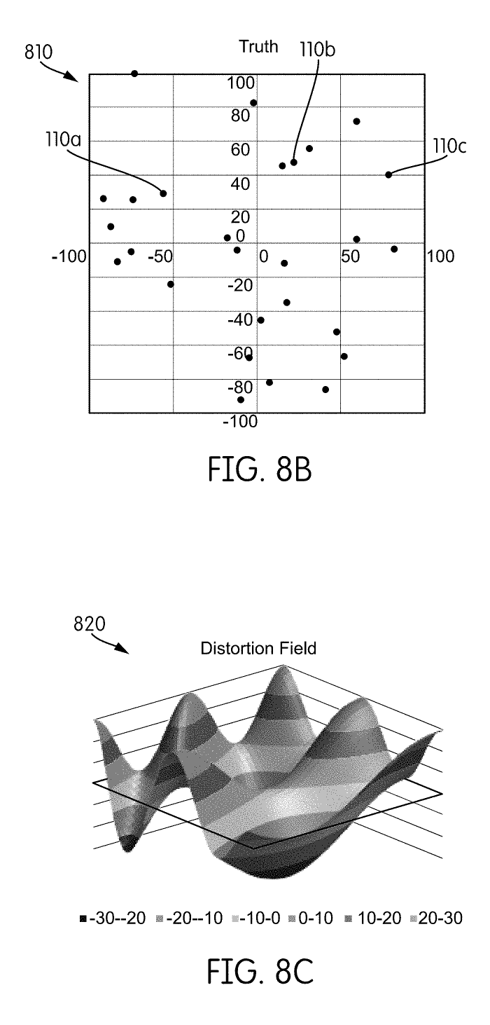

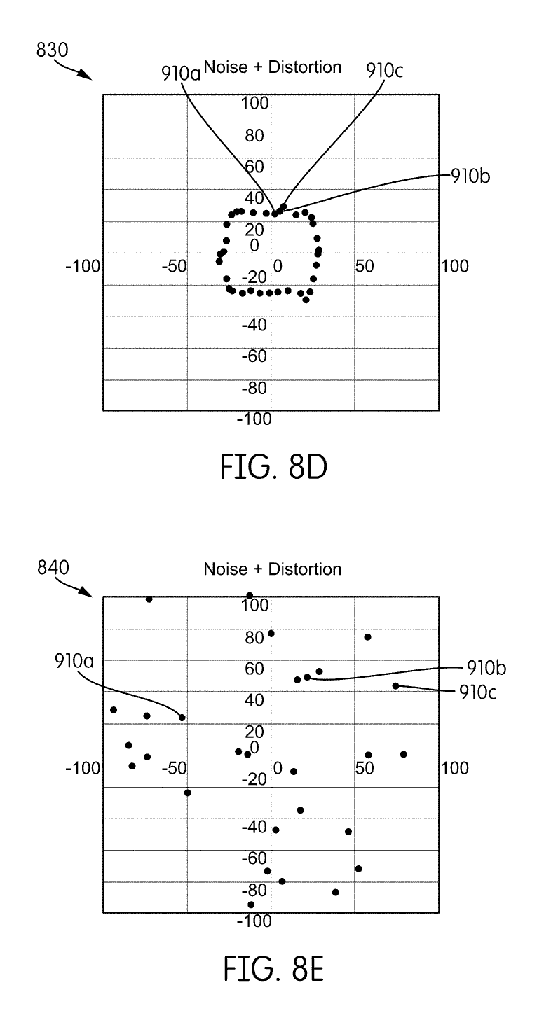

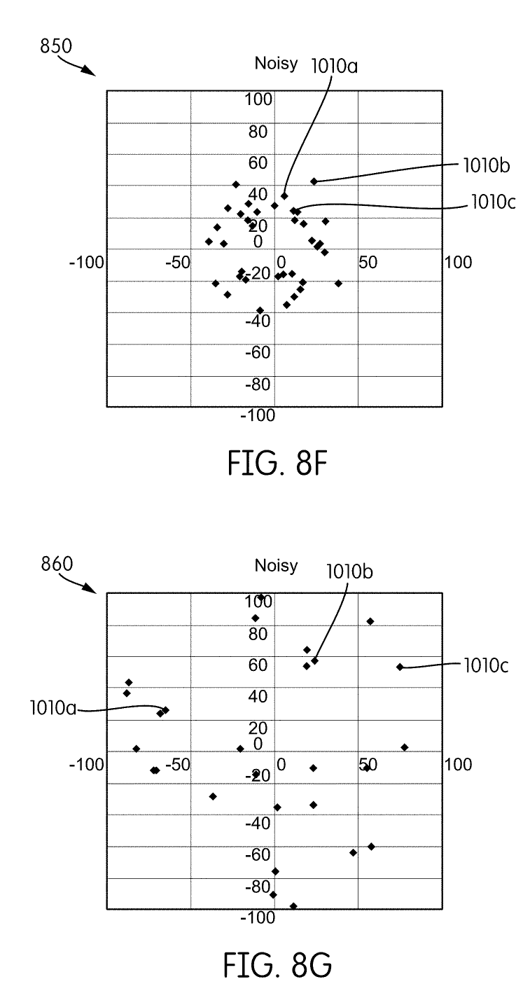

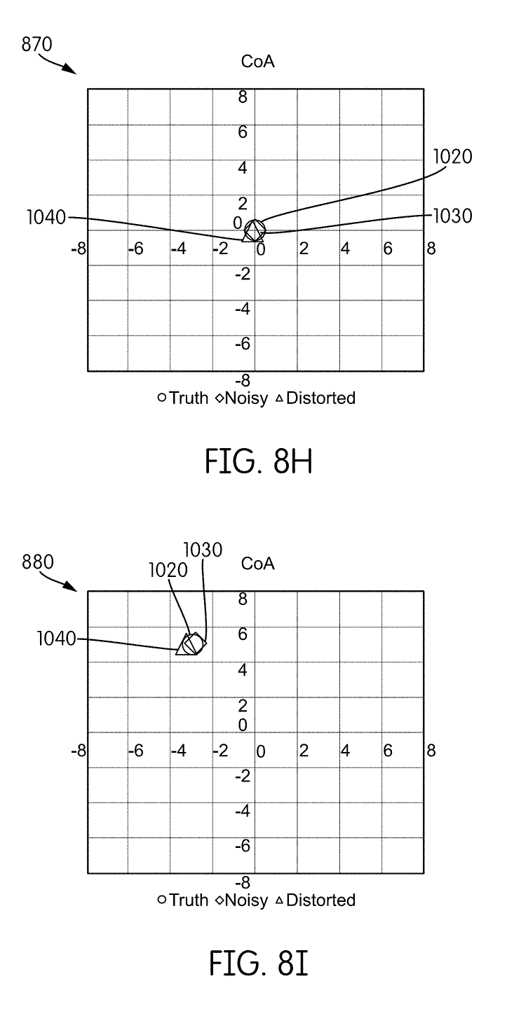

FIGS. 8A-8I illustrate results of a simulation model used to validate the center of activity technique consistent with implementations of the current subject matter. In particular, to demonstrate that the center of activity visualization can deliver accurate information about the center of activity even in noisy positioning environments, a simulation model was built. In this model, virtual entities were moved first in a fixed pattern and then along random trajectories. Random noise of variable amplitude may be injected into the “sensed” position of the entities. A distortion field that moves the sensed position based on an entity's location within the field may also be defined. The center of activity is then calculated over a variable time period for the actual position of the virtual entities and the noisy and distorted positions of the entities. The three center of activity positions are then plotted on a single graph to illustrate the alignment and tracking with respect to each other over time. This sequence is illustrated in FIGS. 8A-8I.

An initial time step (t=100) and a final state (t=300) of the “true” location of the virtual entities 110 are shown in diagrams 800 and 810 of FIGS. 8A and 8B, respectively. Three entities (110a, 110b, and 110c are labeled but as shown additional entities are provided). In the simulation, the entities 110 march in a circle for 100 time steps (FIG. 8A), then head off in random directions (FIG. 8B).

FIG. 8C is a three-dimensional plot of the distortion field 820 used in this run of the model. The distortion field 820 is a variable and configurable sinusoidal surface. For each location on the map, an entity's “sensed” location is moved, or distorted by an amount proportional to the slope of the distortion surface at that location. The following table lists the values used to generate the distortion field for this example.

Sample Distortion Field Configuration
Variables

| | |
|---|---|
| Period X | 25 |
| Amplitude X | 30 |
| Phase X | 0 |
| Progression X | 1 |
| Period Y | 25 |
| Amplitude Y | 30 |
| Phase Y | 0 |
| Progression Y | 0 |

An initial time step (t=100) and a final state (t=300) of the “true” location of the virtual entities 110 are shown in diagrams 800 and 810 of FIGS. 8A and 8B, respectively.

Diagrams 830 and 840 of FIGS. 8D and 8E, respectively, show the sensed locations of the entities at t=100 and at t=300 with the distortion field of FIG. 8C applied. The entities are labeled as 910a, 910b, 910c, corresponding to 110a, 110b, and 110c. Note how this particular distortion field takes the true circle and distorts it into a roughly square shape.

The model also injects random noise at each time step. For this run of the model, the noise range was −30 to +30 in both x and y. Diagram 850 of FIG. 8F shows the sensed location with noise (and no distortion) at t=100 for entities 1010a, 1010b, and 1010c. Note how the true circle is scrambled by the noise. Diagram 860 of FIG. 8G illustrates the sensed location with noise injected at t=300

The model calculates the center of activity at every time step based on the locations from a configurable number of previous time steps. If fewer previous time steps are available at the current time step, all of the previous time steps are used in the calculation. In this run of the model, the previous time steps used in the calculation was set to 300. As a result, at t=100, the previous 99 time steps were used, and at t=300 the previous 299 time steps were used.

The model calculates the center of activity based on three data sets and plots them on a single graph. FIG. 8H shows the center of activity locations for t=100 and FIG. 8I shows them for t=300. In each instance, the center of activity is calculated for the true locations of the virtual entities (1020), the sensed locations with added noise (1030), and the sensed locations with added noise plus distortion (1040).

The following observations can be made. The center of activity of the true data at t=100 is located at (0,0). This is consistent with the fact that the true data is a circle around that location. The center of activity of the true locations moves over the course of the data (in this instance it moves up and to the left and arrives at t=300 at approximately (−3, 5)). This is a result of the random headings the entities adopt between t=101 and t=300. The center of activity of the noisy sensed locations tracks very closely with the center of activity of the true data, beginning and ending at nearly the same location as the true center of activity (in this instance shifted a small amount to the right). The center of activity of the noisy and distorted data also tracks very closely with the center of activity of the true data, beginning and ending at nearly the same location as the true center of activity (in this instance shifted a small amount to the left).

The model was run more than 50 times with different random values for the headings of the true entities and noise values, and the above observations were consistent across all runs. Different distortion fields affected the offset of the distorted data relative to the true locations, but for all reasonable distortions, the distorted center of activity tracked closely with the true center of activity even though it was offset by different amounts depending on the field. The volume of the injected noise and the shape and amplitude of the distortion field were established based on the observed data behavior of location tracking using actual Wi-Fi location data in a warehouse environment.

The model shows that noisy and distorted center of activity locations track closely with the true center of activity locations. Additionally, a mathematical analysis performed on actual sample data from a warehouse using noisy, distorted Wi-Fi position data confirmed that the simulated model is a fair representation of the center of activity technique described herein. The mathematical analysis confirmed that a large amount of data (the collected location data) on the order of 10,000 points per day may be distilled into a single metric that is sensitive to changes in user/equipment behavior. This single metric is the center of activity. The collected data may be noisy, but the noise is weakly correlated in time. Thus if a sufficient amount of measurements are obtained, accuracy is improved.

Using the center of activity technique consistent with implementations of the current subject matter with real-world location data from existing inaccurate tracking systems within warehouses is a low cost, easy to implement way to understand activity in a warehouse and when conditions merit action. By averaging over a month of activity, a small movement of the center of activity multiplied by the number of tasks in a month can reflect significant changes in distance traveled and illustrate the impact of the costs associated with that travel. Therefore, implementing the center of activity system, tracking the sensed center of activity over time, and setting thresholds that trigger the reorganization of the inventory layout (e.g., sorting) can produce significant cost savings benefits for warehouse operations.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
obtaining, by a server, location data for a plurality of entities over a first period of time in a defined area;
calculating, by the server and based on the location data, a center of activity as an average location of the plurality of entities over the first period of time;
generating, by the server, one or more visual representations of the calculated center of activity with respect to the first period of time and the defined area;
providing, by the server and to one or more user devices for display on a respective user interface, the one or more visual representations of the calculated center of activity; and
providing, by the server and to the one or more user devices, an indication in response to a determination that the calculated center of activity moved outside of a predefined tolerance range.

2. The method of claim 1, wherein the center of activity is a weighted, instantaneous average, weighted by a number of the plurality of entities.

3. The method of claim 1, wherein the one or more visual representations comprise an indicator overlaid on a diagram of the defined area, the indicator positioned at the calculated center of activity.

4. The method of claim 3, wherein the one or more visual representations further comprise data from one or more additional data streams.

5. The method of claim 1, further comprising:
obtaining, by the server, location data for the plurality of entities over a second period of time in a defined area; and
calculating, by the server, a second center of activity as an average location of the plurality of entities over the second period of time;
wherein the one or more visual representations include an indicator of the second center of activity.

6. The method of claim 1, further comprising:
determining, by the server, one or more points in the defined area accessed most frequently during the first period of time; and
providing, by the server and to the one or more user devices, an analysis including a recommendation to move the one or more points within the defined area.

7. The method of claim 1, wherein each of the plurality of entities includes a Wi-Fi enabled device, and wherein the location data is obtained via one or more access points configured to receive timing and/or positioning data from the plurality of entities.

8. An apparatus comprising:
at least one processor; and
at least one memory including computer program code, the at least one memory and the computer program code configured to, with the at least one processor, cause the apparatus to at least:
obtain location data for a plurality of entities over a first period of time in a defined area;
calculate, based on the location data, a center of activity as an average location of the plurality of entities over the first period of time;
generate one or more visual representations of the calculated center of activity with respect to the first period of time and the defined area;
provide, to one or more user devices for display on a respective user interface, the one or more visual representations of the calculated center of activity; and
provide, to the one or more user devices, an indication in response to a determination that the calculated center of activity moved outside of a predefined tolerance range.

9. The apparatus of claim 8, wherein the center of activity is a weighted, instantaneous average, weighted by a number of the plurality of entities.

10. The apparatus of claim 8, wherein the one or more visual representations comprise an indicator overlaid on a diagram of the defined area, the indicator positioned at the calculated center of activity.

11. The apparatus of claim 10, wherein the one or more visual representations further comprise data from one or more additional data streams.

12. The apparatus of claim 8, wherein the apparatus is further caused to at least:
obtain location data for the plurality of entities over a second period of time in a defined area; and
calculate a second center of activity as an average location of the plurality of entities over the second period of time;
wherein the one or more visual representations include an indicator of the second center of activity.

13. The apparatus of claim 8, wherein the apparatus is further caused to at least:
determine one or more points in the defined area accessed most frequently during the first period of time; and
provide, to the one or more user devices, an analysis including a recommendation to move the one or more points within the defined area.

14. The apparatus of claim 8, wherein each of the plurality of entities includes a Wi-Fi enabled device, and wherein the location data is obtained via one or more access points configured to receive timing and/or positioning data from the plurality of entities.

15. A computer program product comprising a non-transitory machine-readable medium storing instructions that, when executed by at least one programmable processor, cause the at least one programmable processor to perform operations comprising:
obtaining location data for a plurality of entities over a first period of time in a defined area;
calculating, based on the location data, a center of activity as an average location of the plurality of entities over the first period of time;
generating one or more visual representations of the calculated center of activity with respect to the first period of time and the defined area;
providing, to one or more user devices for display on a respective user interface, the one or more visual representations of the calculated center of activity; and
providing, to the one or more user devices, an indication in response to a determination that the calculated center of activity moved outside of a predefined tolerance range.

16. The computer program product of claim 15, wherein the center of activity is a weighted, instantaneous average, weighted by a number of the plurality of entities.

17. The computer program product of claim 15, wherein the one or more visual representations comprise an indicator overlaid on a diagram of the defined area, the indicator positioned at the calculated center of activity.

18. The computer program product of claim 15, the operations further comprising:
obtaining location data for the plurality of entities over a second period of time in a defined area; and
calculating a second center of activity as an average location of the plurality of entities over the second period of time;
wherein the one or more visual representations include an indicator of the second center of activity.

19. The computer program product of claim 15, the operations further comprising:
determining one or more points in the defined area accessed most frequently during the first period of time; and
providing, to the one or more user devices, an analysis including a recommendation to move the one or more points within the defined area.

20. The computer program product of claim 15, wherein each of the plurality of entities includes a Wi-Fi enabled device, and wherein the location data is obtained via one or more access points configured to receive timing and/or positioning data from the plurality of entities.
